(19) United States
(12) Patent Application Publication
(10) Pub. No.: US 2022/0158522 A1
(43) Pub. Date: May 19, 2022

(54) MOTOR AND DRIVE DEVICE

(71) Applicant: Nidec Corporation, Kyoto (JP)

(72) Inventor: Yuki ISHIKAWA, Kyoto (JP)

(21) Appl. No.: 17/516,118

(22) Filed: Nov. 1, 2021

(30) Foreign Application Priority Data
Nov. 19, 2020 (JP) 2020-192813

(51) Int. Cl. H02K 5/20; H02K 7/116; H02K 9/19

(52) U.S. Cl. CPC H02K 5/203; H02K 9/19; H02K 7/116

(57) ABSTRACT

An inner rotor motor includes a rotor rotatable about a central axis, a stator that includes a stator core that surrounds the rotor from radially outside, and a motor housing that holds the stator. The motor housing includes a tubular portion and a bottom wall. The bottom wall includes a through hole. An inner circumferential surface of the tubular portion includes a first portion that is located at a circumferential position that coincides with the through hole and includes a surface that can come into contact with an outer circumferential surface of the stator core, and a second portion that is located between the first portion and the bottom wall and includes a surface located radially outside relative to the first portion.

### CROSS-REFERENCE TO RELATED APPLICATIONS

The present application claims priority under 35 U.S.C. § 119 to Japanese Patent Application No. 2020-192813, filed on Nov. 19, 2020, the entire contents of which are hereby incorporated herein by reference.

### FIELD OF THE INVENTION

The present disclosure relates to a motor and a drive device.

### BACKGROUND

As a stator fixing structure of a vehicle drive device, for example, there is a configuration in which a stator of a motor is supported in a cantilever manner in a housing. There is another configuration in which a stator supported in a cantilever manner is fixed by a support ring disposed between the stator and a cover inner wall.

In a drive device that supports a stator in a cantilever manner in a housing, the stator is likely to incline in the housing, and center axes of the stator and the rotor are likely to deviate. Therefore, there is a problem that the number of components and the number of assembly man-hours are increased when an additional component for suppressing the inclination of the stator is provided.

On the other hand, a configuration in which a support surface of a stator is provided on an opening side of the inner circumferential surface of a bottomed cylindrical housing needs to be provided with a draft taper on the mold. Hence, it is necessary to cut the entire inner circumferential surface on the bottom side from the support surface so as not to interfere with the stator.

### SUMMARY

According to one example embodiment of the present disclosure, there is provided an inner rotor motor including a rotor rotatable about a central axis, a stator that includes a stator core that surrounds the rotor from radially outside, and a motor housing that holds the stator. The motor housing includes a tubular portion that surrounds the stator from radially outside, and a radially expanding bottom wall that is located at an end of the tubular portion on one side in the axial direction. The bottom wall includes a through hole axially penetrating the bottom wall. An inner circumferential surface of the tubular portion includes a first portion that is located at a circumferential position that coincides with the through hole and includes a surface that can come into contact with an outer circumferential surface of the stator core, and a second portion that is located between the first portion and the bottom wall and includes a surface located radially outside relative to the first portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an overall configuration view schematically Showing a drive device of an example embodiment of the present disclosure.

FIG. 2 is a cross-sectional view of a motor of according to an example embodiment of the present disclosure.

FIG. 3 is a cross-sectional view of a motor according to an example embodiment of the present disclosure.

FIG. 4 is a cross-sectional view of a motor housing according to an example embodiment of the present disclosure.

FIG. 5 is a partial perspective view of a motor housing according to an example embodiment of the present disclosure.

FIG. 6 is a partial cross-sectional view of a motor housing according to an example embodiment of the present disclosure.

FIG. 7 is an explanatory view showing a manufacturing process of a motor housing according to an example embodiment of the present disclosure.

FIG. 8 is a partial cross-sectional view of a motor housing of a modification of an example embodiment of the present disclosure.

FIG. 9 is an explanatory view showing a manufacturing process of a motor housing according to a modification of an example embodiment of the present disclosure.

### DETAILED DESCRIPTION

In the following description, the vertical direction is defined based on a positional relationship in a case where a drive device 1 of each example embodiment shown in each figure is mounted in a vehicle located on a horizontal road surface. In the drawings, an XYZ coordinate system is appropriately shown as a three-dimensional orthogonal coordinate system. In the XYZ coordinate system, the Z axis direction is a vertical direction. The +Z side is the upper side in the vertical direction, and the −Z side is the lower side in the vertical direction. In the following description, the vertically upper side is simply referred to as “upper side”, and the vertically lower side is simply referred to as “lower side”. The X axis direction is a direction orthogonal to the Z axis direction and is a front-rear direction of the vehicle on which the drive device is mounted. In the following example embodiments, the +X side is the front side of the vehicle, and the −X side is the rear side of the vehicle. The Y axis direction is a direction orthogonal to both the X axis direction and the Z axis direction, and is the right-left direction of the vehicle, i.e., the vehicle width direction. In the following example embodiments, the +Y side is the left side of the vehicle, and the −Y side is the right side of the vehicle. The front-rear direction and the right-left direction are horizontal directions orthogonal to the vertical direction.

Note that the positional relationship in the front-rear direction is not limited to the positional relationship of the following example embodiments. The +X side may be the rear side of the vehicle and the −X side may be the front side of the vehicle. In this case, the +Y side is the right side of the vehicle, and the −Y side is the left side of the vehicle.

A motor axis J1 appropriately shown in each figure extends in a direction intersecting the vertical direction. More specifically, the motor axis J1 extends in the Y axis direction, i.e., the right-left direction of the vehicle. Unless otherwise specified in the following description, a direction parallel to the motor axis J1 is simply referred to as an “axial direction”, the radial direction about the motor axis J1 is simply referred to as a “radial direction”, and the circumferential direction about the motor axis J1, i.e., around the axis of the motor axis J1 is simply referred to as a “circumferential direction”. In the present description, a “parallel direction” includes a substantially parallel direction, and an “orthogonal direction” includes a substantially orthogonal direction.

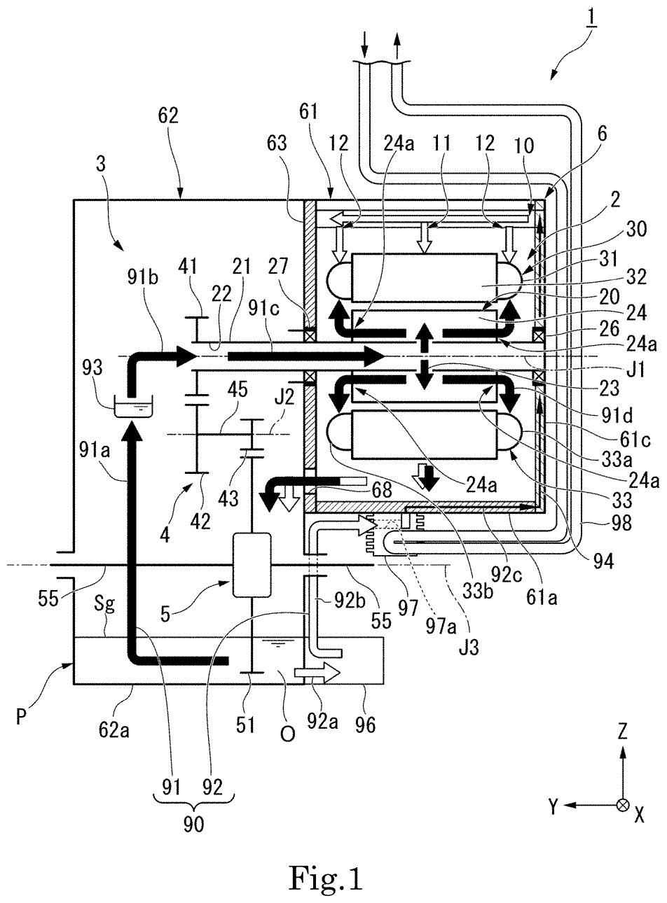

A drive device 1 of the present example embodiment is mounted in a motor-powered vehicle, such as a hybrid vehicle (HEV), a plug-in hybrid vehicle (PHV), and an electric vehicle (EV), and is used as the power source thereof. As shown in FIG. 1, the drive device 1 includes a motor 2, a transmission device 3 including a deceleration device 4 and a differential device 5, a housing 6, an oil pump 96, a cooler 97, and a pipe 10. In the present example embodiment, the drive device 1 does not include an inverter unit, but may include an inverter unit.

The housing 6 accommodates the motor 2 and the transmission device 3 therein. The housing 6 includes a motor housing 61, a gear housing 62, and a partition wall 63. The motor housing 61 accommodates the motor 2 therein. The gear housing 62 accommodates the transmission device 3 therein. The gear housing 62 is continuous to the motor housing 61. In the present example embodiment, the gear housing 62 is located on the left side of the motor housing 61.

The partition wall 63 axially partitions the inside of the motor housing 61 and the inside of the gear housing 62. The motor housing 61 opens toward the right side. In the present example embodiment, the partition wall 63 is a bottom wall located on the side opposite to the opening of the motor housing 61 in the axial direction. The partition wall 63 is located on the left side of a stator 30 and holds a bearing 27 to be described later. The part of the partition wall 63 where the bearing 27 is held is a central part when the partition wall 63 is viewed from the axial direction.

The partition wall 63 has a through hole 68 connecting the inside of the motor housing 61 and the inside of the gear housing 62. The through hole 68 is provided at the lower end of the partition wall 63. The through hole 68 penetrates the lower end of the partition wall 63, for example, axially obliquely downward from a surface on the motor housing 61 side toward a surface on the gear housing 62 side. As a result, an opening 68c of the through hole 68 that opens to the inside of the motor housing 61 opens in an orientation inclined obliquely upward in the vertical direction. An opening 68d of the through hole 68 that opens to the inside of the gear housing 62 opens in an orientation inclined obliquely downward in the vertical direction.

In the present example embodiment, the partition wall 63, the part of the motor housing 61 that surrounds the motor 2 in the circumferential direction, and the part of the gear housing 62 that surrounds the transmission device 3 in the circumferential direction are in an integrally molded body. The molded body is formed by, for example, die casting.

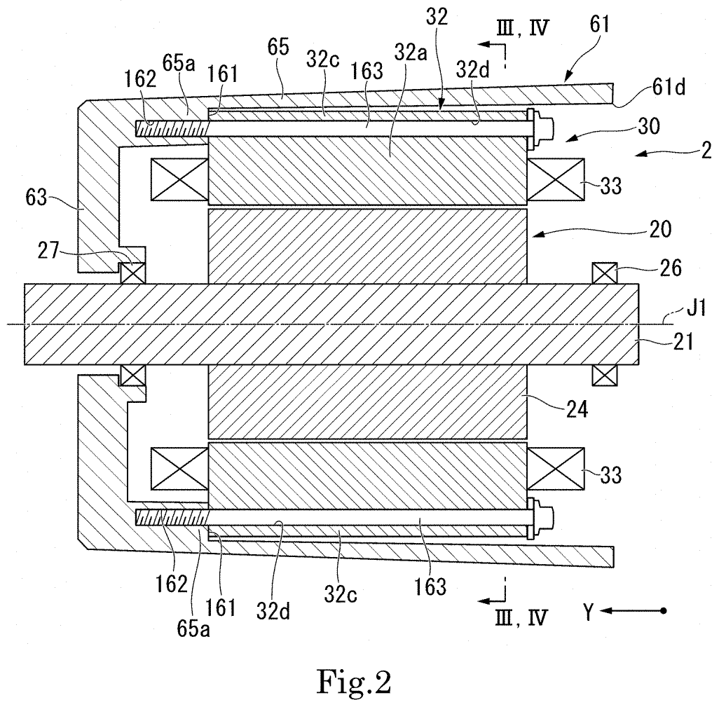

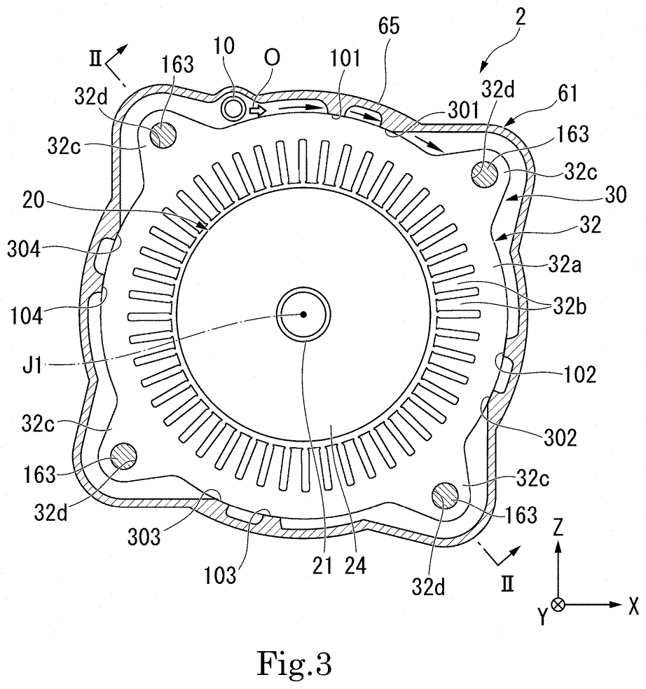

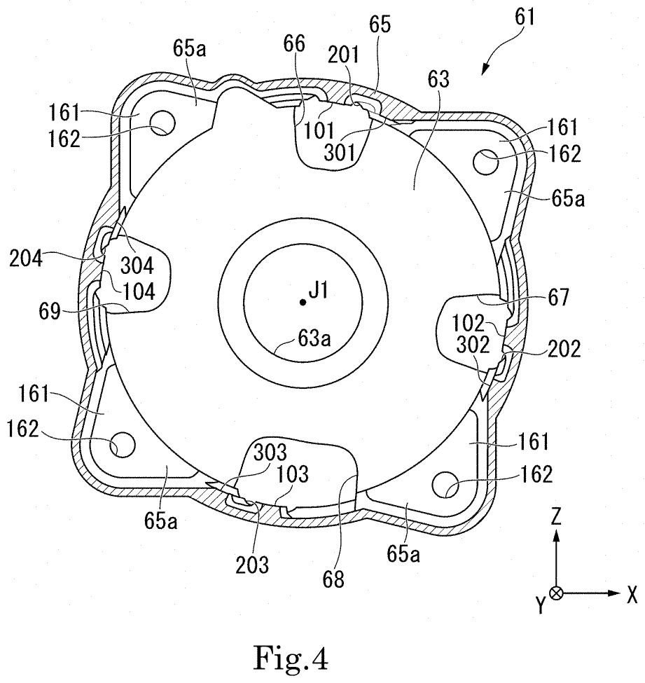

FIG. 2 is a cross-sectional view of the motor 2 on a plane including the motor axis J1. FIG. 3 is a cross-sectional view of the motor 2 on a plane orthogonal to the motor axis J1. FIG. 4 is a partial cross-sectional view of the motor housing 61 as viewed in the axial direction from the right side (−Y side).

The motor 2 is an inner rotor type motor. The motor 2 includes a rotor 20, the stator 30, a bearing 26, and the bearing 27. The rotor 20 is rotatable about the motor axis J1 extending in the horizontal direction. The rotor 20 has a shaft 21 and a rotor body 24. Although not illustrated, the rotor body 24 has a rotor core and a rotor magnet fixed to the rotor core. The torque of the rotor 20 is transmitted to the transmission device 3.

The shaft 21 extends along the axial direction about the motor axis J1. The shaft 21 rotates about the motor axis J1. The shaft 21 is a hollow shaft provided with a hollow portion 22 therein. The shaft 21 is provided with a communication hole 23. The communication hole 23 extends in the radial direction and connects the hollow portion 22 with the outside of the shaft 21.

The shaft 21 extends across the motor housing 61 and the gear housing 62 of the housing 6. The left end of the shaft 21 protrudes into the gear housing 62. A first gear 41, to be described later, of the transmission device 3 is fixed to the left end of the shaft 21. The shaft 21 is rotatably supported by the bearings 26 and 27.

The stator 30 is opposed to the rotor 20 in the radial direction across a gap. More specifically, the stator 30 is located radially outside the rotor 20. The stator 30 has a stator core 32 and a coil assembly 33. The stator core 32 surrounds the rotor 20. The stator core 32 is fixed to an inner circumferential surface of the motor housing 61. As shown in FIG. 3, the stator core 32 includes a cylindrical core back 32a extending in the axial direction, a plurality of teeth 32b extending radially inward from an inner circumferential surface of the core back 32a, and four lug portions 32c protruding radially outward from an outer circumferential surface of the core back 32a. The plurality of teeth 32b are arranged at equal intervals over the entire circumference along the circumferential direction. The four lug portions 32c are arranged at equal intervals of every 90° in the circumferential direction. Each lug portion 32c has a through hole 32d axially penetrating the lug portion 32c.

As shown in FIG. 1, the coil assembly 33 has a plurality of coils 31 attached to the stator core 32 along the circumferential direction. The plurality of coils 31 are mounted to the respective teeth of the stator core 32 via an insulator not illustrated. The plurality of coils 31 are arranged along the circumferential direction. More specifically, the plurality of coils 31 are arranged at equal intervals over the entire circumference along the circumferential direction. Although not illustrated, the coil assembly 33 may have a binding member or the like for binding the coils 31, or may have a connecting wire for connecting the coils 31 with one another.

The coil assembly 33 includes coil ends 33a and 33b that protrude in the axial direction from the stator core 32. The coil end 33a is a part protruding to the right side from the stator core 32. The coil end 33b is a part protruding to the left side from the stator core 32. The coil end 33a includes a part of each coil 31 included in the coil assembly 33 that protrudes on the right side relative to the stator core 32. The coil end 33b includes a part of each coil 31 included in the coil assembly 33 that protrudes on the left side relative to the stator core 32. As shown in FIG. 2, in the present example embodiment, the coil ends 33a and 33b are annular about the motor axis J1. Although not illustrated, the coil ends 33a and 33b may include binding members or the like for binding the coils 31, or may include connecting wires for connecting the coils 31 with one another.

As shown in FIG. 1, the bearings 26 and 27 rotatably support the rotor 20. The bearings 26 and 27 are, for example, ball bearings. The bearing 26 is a bearing rotatably supporting a part of the rotor 20 positioned on the right side relative to the stator core 32. In the present example embodiment, the bearing 26 supports a part of the shaft 21 positioned on the right side relative to the part to which the rotor body 24 is fixed. The bearing 26 is held by a wall portion 61c covering the right side of the rotor 20 and the stator 30 in the motor housing 61. The wall portion 61c is a motor cover that closes the opening on the right side of the motor housing 61.

The bearing 27 is a bearing rotatably supporting a part of the rotor 20 positioned on the left side relative to the stator core 32. In the present example embodiment, the bearing 27 supports a part of the shaft 21 positioned on the left side relative to the part to which the rotor body 24 is fixed. The bearing 27 is held by the partition wall 63.

As shown in FIGS. 2 and 3, the motor housing 61 includes a tubular portion 65 that surrounds the stator from the radially outside, and the partition wall 63 (bottom wall) that is located at an end on the left side (one side in the axial direction) of the tubular portion 65 and expands in the radial direction. The motor housing 61 has a housing opening 61d that opens toward the right side (−Y side, the other side in the axial direction).

As shown in FIG. 2, the tubular portion 65 is axially longer than the stator 30. As shown in FIG. 3, the tubular portion has a substantially cylindrical shape following the outer circumferential surface shape of the stator core 32. The tubular portion 65 has an inner diameter larger than that of other portions at the position of the lug portion 32c of the stator core 32.

The motor housing 61 has a stator fixing portion 65a having a pedestal surface 161 facing the right side (−Y side) at a corner portion where the tubular portion 65 and the partition wall 63 are connected. The stator fixing portions 65a are arranged at four positions in the circumferential direction corresponding to the lug portions 32c of the stator core 32. The four stator fixing portions 65a each have a screw hole 162 opening to the pedestal surface 161 and extending along the axial direction.

The stator 30 is disposed in the motor housing 61 in a state where the lug portion 32c of the stator core 32 is in contact with the pedestal surface 161 of the stator fixing portion 65a. Fixing screws 163 are inserted into the through holes 32d of the four lug portions 32c. When the fixing screw 163 is tightened into the screw hole 162 of a stator fixing portion 64a, the stator 30 is fixed to the motor housing 61.

As shown in FIG. 4, the partition wall 63 has four through holes 66, 67, 68, and 69 axially penetrating the partition wall 63. That is, the bottom wall of the motor housing 61 has the through holes 66 to 69. Each of the through holes 66 to 69 is located between the circumferentially adjacent stator fixing portions 65a. The through hole 66 is located at the upper end (+Z-side end) of the partition wall 63. The through hole 67 is located at the front end (+X side end) of the partition wall 63. The through hole 68 is located at the lower end (−Z-side end) of the partition wall 63. The through hole 69 is located at the rear end (−X side end) of the partition wall 63.

In the drive device 1 of the present example embodiment, the through hole 68 located on the lowermost side among the four through holes 66 to 69 is used as an oil flow path from the motor housing 61 to the gear housing 62. The gear housing 62 is located on the opposite side of the stator 30 across the partition wall 63, which is the bottom wall of the motor housing 61. The through hole 68 as the oil flow path is preferably located on the lower side in the gravity direction than the motor axis J1, which is the central axis of the motor 2.

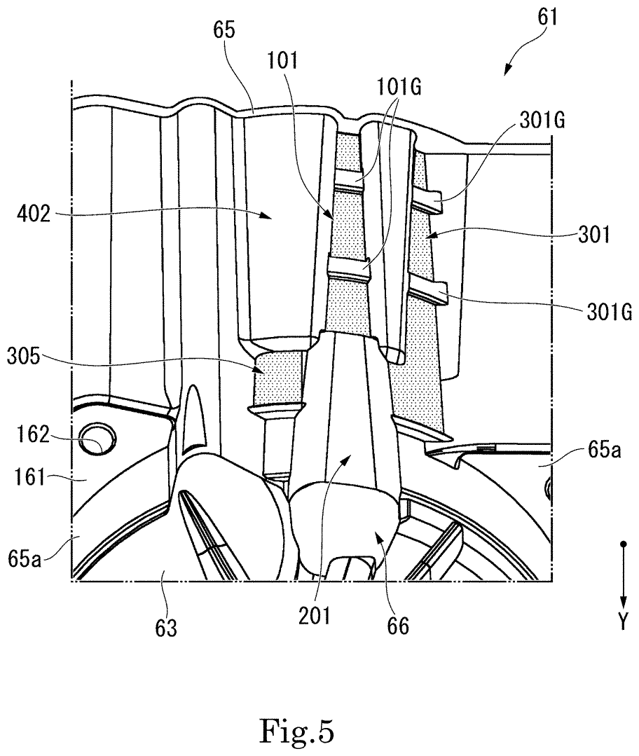

As shown in FIGS. 4 and 5, the motor housing 61 includes, on the inner circumferential surface of the tubular portion 65, first portions 101, 102, 103, and 104 that are positioned at circumferential positions coinciding with the through holes 66 to 69 and include a surface that can be in contact with the outer circumferential surface of the stator core 32, and second portions 201 to 204 that are positioned between the first portions 101 to 104 and the partition wall 63 and include a surface positioned radially outside relative to the first portions 101 to 104.

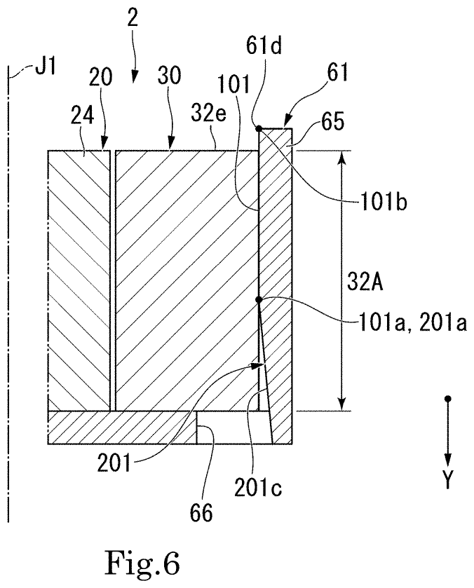

FIG. 6 is a partial cross-sectional view of the motor 2 around the through hole 66.

As shown in FIGS. 5 and 6, the first portion 101 and the second portion 201 are arranged side by side in the axial direction of the motor housing 61. The first portion 101 is a surface that is subjected to cutting work corresponding to the diameter of the stator core 32 in the inner circumferential surface of the tubular portion 65. In the present example embodiment, the second portion 201 is a surface not subjected to cutting work.

As shown in FIG. 3, the first portions 101 to 104 position, from four directions, the outer circumferential surface of the stator core 32 inserted into the tubular portion 65. On the other hand, as shown in FIG. 6, since the second portion 201 is not in contact with the outer circumferential surface of the stator core 32, it is not used for positioning the stator core 32.

In the present example embodiment, the stator core 32 includes a cylindrical body portion including the core back 32a and the teeth 32b, and the plurality of lug portions 32c protruding radially outward from the outer circumferential surface of the body portion. The plurality of lug portions 32c are arranged apart from one another in the circumferential direction. The stator core 32 is fastened and fixed to the motor housing at the lug portion 32c. The motor housing 61 has the plurality of first portions 101, 102, 103, and 104 arranged side by side in the circumferential direction on the inner circumferential surface. Each of the first portions 101, 102, 103, and 104 radially faces the outer circumferential surface of the body portion including the core back 32a and the teeth 32b between the circumferentially adjacent lug portions 32c. According to this configuration, since the positioning by the first portions 101 to 104 is performed on the outer circumferential surface of the core back 32a, which is a columnar surface, the stator 30 can be accurately positioned in the motor housing 61.

In the present example embodiment, the motor 2 is a transversely disposed motor. That is, the motor 2 has the motor axis J1, which is the central axis, disposed along the horizontal direction. As shown in FIG. 3, the first portion 103 located on the lowermost side among the four first portions 101 to 104 supports the outer circumferential surface of the stator core 32 from the lower side to the upper side in the gravity direction. In the present example embodiment, one first portion 103 supports the stator core 32 from below. However, a plurality of first portions may support the stator core 32 from below. According to this configuration, it is possible to suppress the stator 30 from inclining with respect to the motor axis J1 due to the own weight of the stator 30.

The first portion 101 has a shape in which the circumferential width increases from the housing opening 61d toward the partition wall 63 when viewed from the radial direction. Although not illustrated, the other first portions 102, 103, and 104 have the same shape. In the housing 6 manufactured by die casting, since an inclination surface is formed on the inner surface of the tubular portion 65 by the draft taper of the mold, the inner diameter of the tubular portion 65 after casting is smaller on the partition wall 63 side than that on the housing opening 61d side. When the inner surface of the tubular portion 65 is subjected to cutting work for a constant inner diameter in the axial direction, the circumferential width of the cut surface increases toward the partition wall 63 as shown in FIG. 5.

In the present example embodiment, since the second portion 201 exists on the partition wall 63 side of the first portion 101, cutting work of the first portion 101 is interrupted at an end 201a of the second portion 201 on the housing opening side. If the second portion 201 does not exist, the first portion 101 extends to the position of the pedestal surface 161 of the stator fixing portion 65a, the circumferential width of the first portion 101 increases toward the partition wall 63, and the processing depth from the casting surface also increases. In the present example embodiment, since the second portion 201 exists in such a part where the cutting work amount increases, it is possible to greatly reduce the cutting work amount of the motor housing 61. This can also enhance the use efficiency of the material. Therefore, the manufacturing efficiency of the motor housing 61 can be enhanced.

In the present example embodiment, an end 101a of the first portion 101 on the through hole 66 side (+Y side, one side in the axial direction) is disposed in axial contact with the end 201a of the second portion 201 on the housing opening 61d side (−Y side, the other side in the axial direction). An end 101b of the first portion 101 on the housing opening 61d side (−Y side, the other side in the axial direction) is located on the housing opening 61d side (the other side in the axial direction) relative to an end 32e of the stator core 32 on the housing opening side (the other side in the axial direction). The same applies to the other first portions 102, 103, and 104 and the second portions 202, 203, and 204.

According to this configuration, the region from the end of the stator core 32 on the housing opening 61d side to the second portions 202 to 204 can be positioned from the radially outside by the first portions 101 to 104. Since the position of the stator core 32 farthest from the partition wall 63 is positioned with respect to the motor housing 61, the falling of the stator core 32 can be effectively suppressed.

The axial ranges of the first portions 101 to 104 and the second portions 201 to 204 are not limited to the ranges shown in FIGS. 5 and 6.

The ends of the first portions 101 to 104 on the housing opening 61d side (−Y side, the other side in the axial direction) may be located on the housing opening 61d side relative to an axially intermediate position of the stator core 32, and the ends of the second portions 201 to 204 on the partition wall 63 side (+Y side, one side in the axial direction) may be located on one side in the axial direction relative to the axially intermediate position of the stator core 32.

According to this configuration, since the first portions 101 to 104 are arranged in the region located on the housing opening 61d side relative to the intermediate position of the stator core 32 and the region located on the partition wall 63 side relative to the intermediate position of the stator core 32, it is possible to form the first portions 101 to 104 in a relatively wide region in the axial direction while reducing the processing amount of the region close to the partition wall 63 on the inner circumferential surface of the tubular portion 65. This makes it possible to effectively suppress falling of the stator core 32.

The second portions 201 to 204 are formed using the through holes 66 to 69 of the partition wall 63 at the time of casting the housing 6.

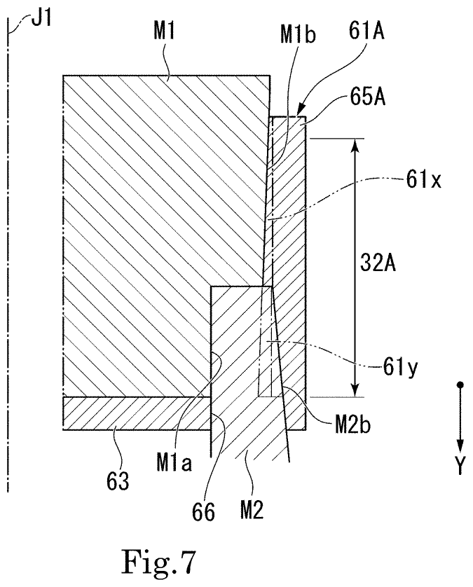

FIG. 7 is an explanatory view showing the manufacturing process of the motor housing 61.

As shown in FIG. 7, the inner circumferential side of the motor housing 61 is manufactured by die casting using two molds M1 and M2. Description of the outer circumferential side of the motor housing 61 and other parts of the housing 6 will be omitted.

The mold M1 is a mold extending from the other side (−Y side) in the axial direction toward the one side (+Y side) in the axial direction. The mold M2 is a mold extending from one side (+Y side) in the axial direction toward the other side (−Y side) in the axial direction. The mold M1 has a recess M1a into which the mold M2 is inserted. By advancing and meshing the molds M1 and M2 in the axial direction, a cavity for casting the motor housing 61 is formed between the molds M1 and M2. As shown in FIG. 7, the motor housing 61 is manufactured by supplying molten metal to a cavity surrounded by the molds M1 and M2 and then cooling the cavity.

In the motor housing 61 manufactured in the above manufacturing process, a part to become the first portion 101 is formed by an outer circumferential surface M1b of the mold M1. As shown in FIG. 6, a range 32A shown in FIG. 7 is a range in the axial direction of the stator core 32 accommodated in the motor housing 61. A tubular portion 65A of a cast 61A to become the motor housing 61 is formed to have a size including the range 32A in the axial direction of the stator core 32 in the axial direction. Due to the draft taper provided on the outer circumferential surface M1b of the mold M1, the inner diameter of the inner circumferential surface of the tubular portion 65A decreases from the other side (−Y side) in the axial direction toward the one side (+Y side) in the axial direction. After casting, a removal part 61x shown in FIG. 7 is removed by cutting work, whereby the tubular portion 65 having the first portion 101 on the inner circumferential surface can be manufactured.

The second portion 201 is formed by an outer circumferential surface M2b of the mold M2. The mold M2 is pulled out from the through hole 66 to the one side (+Y side) in the axial direction. Hence, by the draft taper provided on the outer circumferential surface M2b of the mold M2, the surface of the second portion 201 facing the radially inner side becomes an inclination surface that expands radially outward toward the one side (+Y side) in the axial direction. As a result, an inclination surface 201c shown in FIG. 6 is formed.

According to the above manufacturing process, the through hole 66 and the second portion 201 are formed by the mold M2. Therefore, in the manufactured motor housing 61, the through hole 66 is located at the outer circumferential end of the partition wall 63 inside the tubular portion 65, and a part of the through hole 66 is located radially outside relative to the inner circumferential surface of the tubular portion 65. The other through holes 67 to 69 are similar to the through hole 66.

Since the mold M2 is pulled out from the through hole 66 after casting, the circumferential width of the second portion 201 formed on the other side (−Y side) in the axial direction relative to the through hole 66 becomes equal to or less than the circumferential width of the through hole 66. The other second portions 202 to 204 are similar to the second portion 201.

According to the manufacturing method of the present example embodiment, as shown in FIG. 7, by forming the inner circumferential surface of the tubular portion 65A using the molds M1 and M2, the volume of the removal part 61x for forming the first portions 101 to 104 can be made small. If the inner circumferential surface of the tubular portion 65A is formed using only the mold M1, the inner circumferential surface of the tubular portion 65A becomes an inclination surface due to the draft taper of the outer circumferential surface M1b, and hence a removal part 61y indicated by an imaginary line in FIG. 7 also needs to be removed by cutting work. In the present example embodiment, since use of the mold M2 prevents the removal part 61y from being formed in the tubular portion 65A, it is possible to form the first portion 101 only by thinly scraping the removal part 61x.

In addition, the axial length of the second portion 201 can be freely adjusted only by changing the axial length of the mold M2, and hence it is easy to change the axial position of the first portion 101 that positions the stator core 32. The first portion 101 can be easily disposed at a position where falling of the stator 30 is unlikely to occur.

In the present example embodiment, the second portion 201 includes the inclination surface 201c that is inclined radially outward from the boundary with the first portion 101 toward the partition wall 63 side (+Y side, one side in the axial direction). The through hole 66 has a cross-sectional area of the hole gradually increasing from the other side (−Y side) in the axial direction toward one side (+Y side) in the axial direction. Although not illustrated, the other second portions 202 to 204 also have the same structure as that of the second portion 201. The other through holes 67 to 69 also have the same configuration as that of the through hole 66.

As described above, since the mold M2 forming the second portions 201 to 204 and the through holes 66 to 69 protrudes from the one side (+Y side) in the axial direction of the partition wall 63 toward the other side (−Y side) in the axial direction. Hence, by the draft taper of the mold M2, the inclination surface is provided on the inner circumferential surfaces of the second portions 201 to 204 and the through holes 66 to 69. In the present example embodiment, the through hole 68 located on the lowermost side among the four through holes 66 to 69 is used as the oil flow path for flowing an oil O from the motor housing 61 to the gear housing 62. By using the through hole 68 for pulling the mold forming the second portion 203 as the flow path for the oil O, it is not necessary to provide a through hole for an oil flow path on the partition wall 63, and the number of through holes can be reduced, and hence the rigidity of the motor housing 61 is hardly reduced.

When the second portion 203 extending from the housing opening 61d side and connected to the through hole 68 has a shape inclined downward toward one side (+Y side) in the axial direction, the oil O in the motor housing 61 can be smoothly guided to the through hole 68.

In addition, when the through hole 68 has a shape in which the cross-sectional area of the hole increases toward one side in the axial direction, the surface of the through hole 68 becomes a surface inclined downward from the motor housing 61 toward the gear housing 62, and thus it is possible to smoothly flow the oil O from the motor housing 61 toward the gear housing 62. In addition, since the surface of the second portion 203 connected to the through hole 68 also becomes a surface inclined downward from the motor housing 61 toward the gear housing 62, it is possible to smoothly flow the oil O from the motor housing 61 toward the gear housing 62.

In addition, the motor housing 61 further includes third portions 301 to 304 that are located at a circumferential position different from that of the first portions 101 to 104 and the second portions 201 to 204, and include a surface that can come into contact with the outer circumferential surface of the stator core 32. According to this configuration, the stator core 32 is positioned from the radially outside by the four third portions 301 to 304 in addition to the four first portions 101 to 104. This makes it possible to suppress more effectively falling of the stator 30.

In the case of the present example embodiment, the third portion 301 extends over the entire stator core 32 in the axial direction. That is, the end of the third portion 301 on the housing opening 61d side coincides with the end 32e of the stator core 32 on the housing opening 61d side or is located on the housing opening 61d side relative to the end 32e. The end of the third portion 301 on the partition wall 63 side reaches the end of the stator core 32 on the partition wall 63 side. The other third portions 302, 303, and 304 also have the same configuration as that of the third portion 301. According to this configuration, since the outer circumferential surface of the stator core 32 can be positioned over the entire axial length, falling of the stator 30 can be further suppressed.

As shown in FIG. 3, the third portion 303 located on the lowermost side among the four third portions 301 to 304 supports the outer circumferential surface of the stator core 32 from the lower side to the upper side in the gravity direction. In the present example embodiment, one third portion 303 supports the stator core 32 from below. However, a plurality of third portions may support the stator core 32 from below. According to this configuration, it is possible to suppress the stator 30 from inclining with respect to the motor axis J1 due to the own weight of the stator 30.

The third portion 301 has a shape in which the circumferential width increases from the housing opening 61d toward the partition wall 63 when viewed from the radial direction. Although not illustrated, the other third portions 302, 303, and 304 have the same shape. The third portions 301 to 304 have such a shape because similarly to the first portions 101 to 104, the inner surface of the tubular portion 65 is an inclination surface by the draft taper of the mold.

The axial lengths of the third portions 301 to 304 can be changed. That is, the ends of the third portions 301 to 304 on the housing opening 61d side may be positioned on the partition wall 63 side relative to the end 32e of the stator core 32 on the housing opening 61d side. Furthermore, the ends of the third portions 301 to 304 on the partition wall 63 side may be positioned on the housing opening 61d side relative to the end of the stator core 32 on the partition wall 63 side. Furthermore, the third portions 301 to 304 may be divided into a plurality of regions in the axial direction.

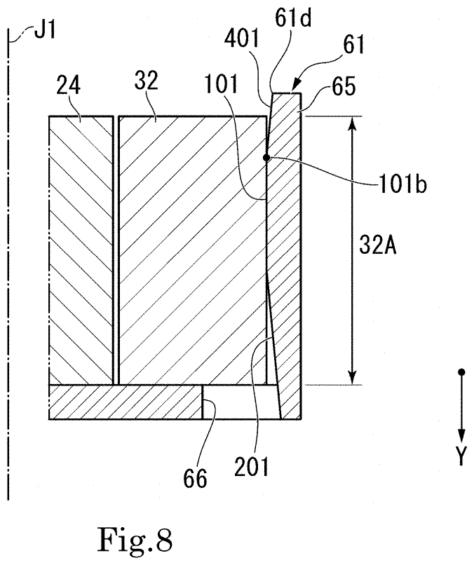

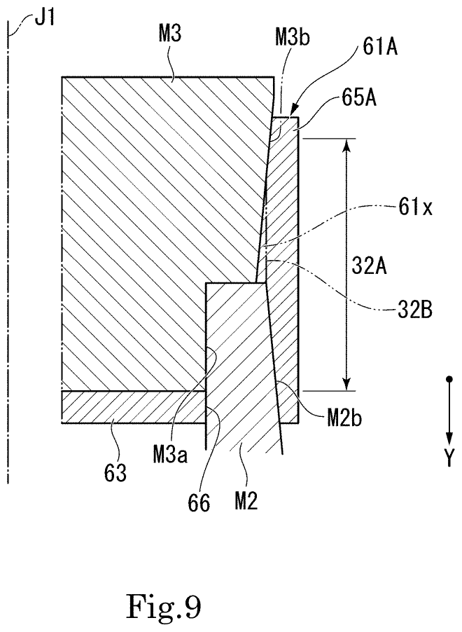

Furthermore, as shown in FIG. 5, the motor housing 61 of the present example embodiment has a third portion 305 on the side of the second portion 201 opposite to the third portion 301 in the circumferential direction. According to this configuration, in the periphery of the second portion 201, the end of the stator core 32 on the partition wall 63 side can be positioned by the two third portions 301 and 305. The third portion 305 may be provided as necessary. The motor housing 61 of the present example embodiment includes a fourth portion 402 having an inner diameter larger than that of the third portion 305 on the other side (−Y side) in the axial direction of the third portion 305. The fourth portion 402 is circumferentially adjacent to the first portion 101. The fourth portion 402 has an inner diameter larger than that of the first portion 101. By including the fourth portion 402, it is possible to easily form the third portion 305 at a necessary axial position with a necessary axial length without increasing the amount of cutting work. A method for forming the fourth portion 402 will be described in detail with reference to FIGS. 8 and 9 in a modification described later.

As shown in FIG. 5, the motor housing 61 of the present example embodiment has a plurality of refrigerant flow paths 101G including a groove crossing the first portion 101 in the circumferential direction. In addition, the motor housing 61 has a plurality of refrigerant flow paths 301G including a groove circumferentially crossing the third portion 301. As shown in FIG. 3, the pipe 10 for flowing the oil O to the stator 30 is disposed above the stator core 32. Details of the configuration and function of the pipe 10 will be described later.

As shown in FIG. 3, in the motor housing 61 of the present example embodiment, surfaces of the first portions 101 to 104 facing radially inward and surfaces of the third portions 301 to 304 facing radially inward are in contact or in proximity with the outer circumferential surface of the stator core 32 in order to position the stator core 32. Therefore, the first portion 101 and the third portion 301 can be parts that inhibit the flow of the oil O supplied from the pipe 10 to the upper surface of the stator core 32. In the present example embodiment, since the refrigerant flow paths 101G and 301G are provided in the first portion 101 and the third portion 301, the oil O on the stator core 32 can flow in the circumferential direction through the refrigerant flow paths 101G and 301G. This makes it possible to efficiently cool the stator 30.

In the present example embodiment, the number of refrigerant flow paths 101G is two and the number of refrigerant flow paths 301G is two. However, each of them may be one or three or more. The motor housing 61 may be configured to have only the refrigerant flow path 101G or may be configured to have only the refrigerant flow path 301G. Although not illustrated, the other first portions 102 to 104 and the other third portions 302 to 304 may also include a refrigerant flow path including a groove similar to that of the refrigerant flow paths 101G and 301G.

In the present example embodiment, as shown in FIG. 3, in the inner circumferential surface of the tubular portion 65, parts other than the first portions 101 to 104 and the third portions 301 to 304 are disposed radially outward away from the outer circumferential surface of the stator core 32. Therefore, what inhibit the circulation of the oil O are only the first portions 101 to 104 and the third portions 301 to 304. Since the groove for circulating the oil O are only required to be provided in the first portions 101 to 104 and the third portions 301 to 304, the region requiring processing can be narrowed.

In the present example embodiment, as shown in FIG. 6, the end 101b of the first portion 101 on the housing opening 61d side is located on the housing opening 61d side relative to the end 32e of the stator core 32. However, the end 101b of the first portion 101 may be located on the partition wall 63 side relative to the end 32e of the stator core 32. This example will be described with reference to FIG. 8.

FIG. 8 is a partial cross-sectional view of a motor housing of a modification.

As shown in FIG. 8, the motor housing 61 of the modification includes a fourth portion 401 including a surface located radially outside relative to the outer circumferential surface of the stator core 32 on the housing opening 61d side (−Y side, the other side in the axial direction) of the first portion 101.

Similarly to the second portion 201, the fourth portion 401 includes a casting surface not subjected to cutting work. Since the motor housing 61 of the modification is provided with the fourth portion 401, the axial length of the first portion 101 is shorter than that of the example embodiment shown in FIG. 6. Since the range of the first portion 101 formed by cutting work is narrow, the burden of cutting work is small, the use efficiency of the material becomes high, and the manufacturing efficiency of the motor housing 61 is improved.

A fourth portion similar to the fourth portion 401 may be provided on the housing opening 61d side (the other side in the axial direction) of the other first portions 102, 103, and 104. FIG. 9 is an explanatory view showing the manufacturing process of the motor housing 61 of the modification shown in FIG. 8.

The motor housing 61 of the modification having the fourth portion 401 can be manufactured by die casting using a mold M3 and the mold M2 shown in FIG. 9.

The mold M3 has substantially the same configuration as that of the mold M1 shown in FIG. 7. However, an outer circumferential surface M3b is located on the radially outside as compared with that of the mold M1. Due to this, a part of the mold M3 close to the other side in the axial direction is disposed radially outside relative to a position 32B where the outer circumferential surface of the stator core 32 is disposed.

In a cast 61A manufactured using the molds M3 and M2, when the inner circumferential surface is cut in accordance with the outer circumferential surface of the stator core 32, only the removal part 61x shown in FIG. 8 is cut, and one side in the axial direction and the other side in the axial direction of the removal part 61x are not cut. As described above, the motor housing 61 of the modification shown in FIG. 8 can be manufactured. According to the manufacturing method of the modification, the volume of the removal part 61x removed by cutting work can be reduced.

Returning to FIG. 1, the housing 6 accommodates the oil O as a refrigerant therein. In the present example embodiment, the oil O is accommodated inside the motor housing 61 and inside the gear housing 62. A lower region inside of the gear housing 62 is provided with an oil pool P in which the oil O accumulates. The oil O in the oil pool P is sent to the inside of the motor housing 61 through an oil passage 90 described later. The oil O sent to the inside of the motor housing 61 accumulates in a lower region inside the motor housing 61. At least a part of the oil O accumulated in the motor housing 61 moves to the gear housing 62 through the through hole 68 and returns to the oil pool P.

Note that when “the oil is accommodated in a certain part” in the present specification, the oil is only required to be positioned in a certain part at least in a part when the motor is being driven, and the oil may not be positioned in a certain part when the motor is stopped. For example, when the oil O is accommodated in the motor housing 61 in the present example embodiment, the oil O is only required to be positioned in the motor housing 61 at least in part when the motor 2 is being driven, and the oil O in the motor housing 61 may entirely be moved to the gear housing 62 through the through hole 68 when the motor 2 is stopped. A part of the oil O sent to the inside of the motor housing 61 through the oil passage 90 described later may remain inside the motor housing 61 in a state where the motor 2 is stopped.

The oil O circulates in the oil passage 90 described later. The oil O is used for lubrication of the deceleration device 4 and the differential device 5. The oil O is used for cooling the motor 2. As the oil O, an oil equivalent to an automatic transmission fluid (ATF) having a relatively low viscosity is preferably used in order to perform the function of lubricating oil and cooling oil.

The transmission device 3 is accommodated in the gear housing 62 of the housing 6. The transmission device 3 is connected to the motor 2. More specifically, the transmission device 3 is connected to the left end of the shaft 21. The transmission device 3 includes the deceleration device 4 and the differential device 5. The torque output from the motor 2 is transmitted to the differential device 5 via the deceleration device 4.

The deceleration device 4 is connected to the motor 2. The deceleration device 4 reduces the rotational speed of the motor 2 and increases the torque output from the motor 2 according to the reduction ratio. The deceleration device 4 transmits torque outputted from the motor 2 to the differential device 5. The deceleration device 4 has a first gear 41, a second gear 42, a third gear 43, and an intermediate shaft 45.

The first gear 41 is fixed to the outer circumferential surface at the left end of the shaft 21. The first gear 41, together with the shaft 21, rotates about the motor axis J1. The intermediate shaft 45 extends along an intermediate axis J2 parallel to the motor axis J1. The intermediate shaft 45 rotates about the intermediate axis J2. The second gear 42 and the third gear 43 are fixed to the outer circumferential surface of the intermediate shaft 45. The second gear 42 and the third gear 43 are connected via the intermediate shaft 45. The second gear 42 and the third gear 43 rotate about the intermediate axis J2. The second gear 42 meshes with the first gear 41. The third gear 43 meshes with a ring gear 51 described later of the differential device 5.

The torque output from the motor 2 is transmitted to the ring gear 51 of the differential device 5 via the shaft 21, the first gear 41, the second gear 42, the intermediate shaft 45, and the third gear 43 in this order. The gear ratio of each gear, the number of gears, and the like can be variously changed according to the required reduction ratio. In the present example embodiment, the deceleration device 4 is a parallel axis gear type deceleration device in which the axis centers of the gears are disposed in parallel.

The differential device 5 is connected to the motor 2 via the deceleration device 4. The differential device 5 is a device for transmitting the torque output from the motor 2 to the wheels of the vehicle. The differential device 5 transmits the same torque to axles 55 of the right and left wheels while absorbing the speed difference between the right and left wheels when the vehicle turns. As described above, in the present example embodiment, the transmission device 3 transmits the torque of the motor 2 to the axle 55 of the vehicle via the deceleration device and the differential device 5. The differential device 5 includes a ring gear 51, a gear housing not illustrated, a pair of pinion gears not illustrated, a pinion shaft not illustrated, and a pair of side gears not illustrated. The ring gear 51 rotates about a differential axis J3 parallel to the motor axis J1. Thus, the torque output from the motor 2 is transmitted to the ring gear 51 via the deceleration device 4.

The motor 2 is provided with the oil passage 90 for circulating the oil O inside the housing 6. The oil passage 90 is a path for supplying the oil O from the oil pool P to the motor 2 and guiding the oil O to the oil pool P again. The oil passage 90 is provided across the inside of the motor housing 61 and the inside of the gear housing 62.

Note that in this description, the term “oil passage” means a path of oil. Therefore, the term “oil passage” is a concept including not only a “flow path” that creates a steady unidirectional flow of oil, but also a path for temporarily retaining oil and a path for oil to drip off. The path for temporarily retaining oil includes, for example, a reservoir for storing the oil.

The oil passage 90 has a first oil passage 91 and a second oil passage 92. The first oil passage 91 and the second oil passage 92 each circulate the oil O inside the housing 6. The first oil passage 91 has a scoop path 91a, a shaft supply path 91b, an in-shaft path 91c, and an in-rotor path 91d. A first reservoir 93 is provided in the path of the first oil passage 91. The first reservoir 93 is provided in the gear housing 62.

The scoop path 91a is a path for scooping the oil O from the oil pool P by rotation of the ring gear 51 of the differential device 5 and receiving the oil O in the first reservoir 93. The first reservoir 93 opens upward. The first reservoir 93 receives the oil O scooped by the ring gear 51. When the liquid level Sg of the oil pool P is high immediately after the motor 2 is driven, the first reservoir 93 also receives the oil O scooped by the second gear 42 and the third gear 43 in addition to the ring gear 51.

The shaft supply path 91b guides the oil O from the first reservoir 93 to the hollow portion 22 of the shaft 21. The in-shaft path 91c is a path for the oil O to pass through the hollow portion 22 of the shaft 21. The in-rotor path 91d is a path passing through the inside of the rotor body 24 from the communication hole 23 of the shaft 21 and scatters to the stator 30.

The in-rotor path 91d has a supply port 24a provided in the rotor body 24. The supply port 24a opens to the inside of the motor housing 61. The oil O passing through the in-rotor path 91d is injected from the supply port 24a toward the stator 30. In this manner, the supply port 24a supplies the oil O as a fluid to the inside of the motor housing 61. For example, a plurality of supply ports 24a are provided. In the present example embodiment, the rotor body 24 corresponds to a supply portion having the supply port 24a.

In the in-shaft path 91c, centrifugal force is applied to the oil O inside the rotor 20 due to the rotation of the rotor 20. Thus, the oil O is continuously scattered radially outward from the rotor 20. With the scattering of the oil O, the path inside the rotor 20 becomes negative pressure, and the oil O accumulated in the first reservoir 93 is sucked into the rotor 20, and the path inside the rotor 20 is filled with the oil O.

The oil O having reached the stator 30 absorbs heat from the stator 30. The oil O having cooled the stator 30 drips to the lower side and accumulated in the lower region in the motor housing 61. The oil O accumulated in the lower region in the motor housing moves to the gear housing 62 through the through hole 68 provided in the partition wall 63. As described above, the first oil passage 91 supplies the oil O to the rotor 20 and the stator 30.

In the second oil passage 92, the oil O is lifted up from the oil pool P and supplied to the stator 30. The second oil passage 92 is provided with the oil pump 96, the cooler 97, and pipe 10. The second oil passage 92 has a first flow path 92a, a second flow path 92b, a third flow path 92c, and a fourth flow path 94.

The first flow path 92a, the second flow path 92b, the third flow path 92c, and the fourth flow path 94 are provided on the wall portion of the housing 6. The first flow path 92a connects the oil pool P and the oil pump 96. The second flow path 92b connects the oil pump 96 and the cooler 97. The third flow path 92c connects the cooler 97 with the fourth flow path 94. The third flow path 92c is provided on a wall portion of the motor housing 61 on the wall portion of the right side (−Y side). The fourth flow path 94 is provided on the wall portion 61c. The fourth flow path 94 connects the third flow path 92c with the pipe 10.

In the present example embodiment, the pipe 10 extends in the axial direction. The right end of the pipe 10 is fixed to the wall portion 61c. In the present example embodiment, the pipe has a cylindrical shape extending linearly in the axial direction. The pipe 10 is accommodated inside the housing 6. The pipe 10 is located radially outside the stator 30. The pipe 10 is located above the stator 30, for example. A plurality of pipes 10 may be provided.

The pipe 10 has supply ports 11 and 12 for supplying the oil O as a fluid to the inside of the motor housing 61. The supply ports 11 and 12 open to the inside of the motor housing 61. The oil O flowing into the pipe 10 from the fourth flow path 94 is injected from the supply ports 11 and 12 toward the stator 30. The oil O injected from the supply port 11 is supplied to the stator core 32. The oil O injected from the supply port 12 is supplied to the coil ends 33a and 33b. For example, a plurality of supply ports 11 and a plurality of supply ports 12 are provided. In the present example embodiment, the pipe 10 corresponds to a supply portion having the supply ports 11 and 12.

The oil pump 96 is a pump that sends the oil O as a refrigerant. In the present example embodiment, the oil pump 96 is an electricity-driven electric pump. The oil pump 96 sucks up the oil O from the oil pool P via the first flow path 92a, and supplies the oil O to the motor 2 via the second flow path 92b, the cooler 97, the third flow path 92c, the fourth flow path 94, and the pipe 10.

The oil O supplied from the pipe 10 to the stator 30 drips to the lower side and accumulated in the lower region in the motor housing 61. The oil O accumulated in the lower region in the motor housing 61 moves to the oil pool P the gear housing 62 through the through hole 68 provided in the partition wall 63. In the above-described manner, the second oil passage 92 supplies the oil O to the stator 30.

The cooler 97 cools the oil O passing through the second oil passage 92. The second flow path 92b and the third flow path 92c are connected to the cooler 97. The cooler 97 has a flow path 97a connecting the second flow path 92b with the third flow path 92c. The flow path 97a is a flow path provided inside the cooler 97. The flow path 97a is connected to the inside of the gear housing 62 via the second flow path 92b and the first flow path 92a. The cooler 97 is connected with a cooling water pipe 98 through which cooling water cooled by a radiator not illustrated is caused to pass. The oil O passing through the flow path 97a provided inside the cooler 97 is cooled by heat exchange with the cooling water passing through the cooling water pipe 98.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An inner rotor motor comprising:
a rotor rotatable about a central axis;
a stator that includes a stator core that surrounds the rotor from radially outside; and
a motor housing that holds the stator; wherein
the motor housing includes a tubular portion that surrounds the stator from radially outside, and a radially expanding bottom wall that is located at an end of the tubular portion on one side in an axial direction;
the bottom wall includes a through hole axially penetrating the bottom wall;
an inner circumferential surface of the tubular portion includes;
a first portion that is located at a circumferential position that coincides with the through hole and includes a surface that is structured to be able to come into contact with an outer circumferential surface of the stator core; and
a second portion that is located between the first portion and the bottom wall and includes a surface located radially outside relative to the first portion.

2. The motor according to claim 1, wherein
an end of the first portion on one side in an axial direction is in axial contact with an end of the second portion on another side in an axial direction and
an end of the first portion on another side in an axial direction is located on another side in an axial direction relative to an end of the stator core on another side in an axial direction.

3. The motor according to claim 1, wherein
the through hole is located in an outer circumferential portion of the bottom wall.

4. The motor according to claim 3, wherein
a circumferential width of the second portion is equal to or less than a circumferential width of the through hole.

5. The motor according to claim 1, wherein
an end of the first portion on another side in an axial direction is located on another side in an axial direction relative to an axially intermediate position of the stator core; and
an end of the second portion on one side in an axial direction is located on one side in an axial direction relative to an axially intermediate position of the stator core.

6. The motor according to claim 1, wherein
the second portion includes an inclination surface that is inclined radially outward from a boundary with the first portion toward one side in an axial direction.

7. The motor according to claim 1, wherein
the stator core includes an axially extending cylindrical body portion, and lug portions that protrude radially outward from an outer circumferential surface of the body portion;
the lug portions are spaced apart from one another in a circumferential direction;
the stator core is fastened and fixed to the motor housing at the lug portions;
the motor housing includes a plurality of the first portions side by side in a circumferential direction on an inner circumferential surface; and
each of the plurality of first portions radially opposes an outer circumferential surface of the body portion between the lug portions adjacent circumferentially.

8. The motor according to claim 1, wherein
the motor is a transversely positioned motor including a central axis positioned along a horizontal direction;
at least one of the first portions in the motor housing supports an outer circumferential surface of the stator core from a lower side in a gravity direction.

9. The motor according to claim 1, wherein
the through hole has a cross-sectional area of a hole gradually increasing from another side in an axial direction toward one side in an axial direction.

10. The motor according to claim 1, further comprising:
a third portion that is located at a circumferential position different from circumferential positions of the first portion and the second portion, and include a surface that can come into contact with an outer circumferential surface of the stator core.

11. The motor according to claim 10, wherein
the motor is a transversely positioned motor having a central axis extending along a horizontal direction; and
at least one of the third portions in the motor housing supports an outer circumferential surface of the stator core from a lower side in a gravity direction.

12. The motor according to claim 1, further comprising:
a fourth portion that includes a surface located radially outside relative to an outer circumferential surface of the stator core, on another side in an axial direction of the first portion.

13. A drive device comprising:
the motor according to claim 1; and
a decelerator coupled to the motor; wherein
the motor is transversely positioned;
a refrigerant to circulate inside the motor and the decelerator is provided;
the decelerator is located on an opposite side of the stator across a bottom wall of the motor housing; and
the through hole of the bottom wall is located on a lower side in a gravity direction than the central axis.

14. A drive device comprising:
the motor according to claim 1; and
a decelerator that is coupled to the motor; wherein
the motor is transversely positioned;
a refrigerant to circulate inside the motor and the decelerator is provided; and
the motor housing includes:
a refrigerant supply to flow a refrigerant on an upper surface of the stator; and
a refrigerant flow path that includes a groove that circumferentially crosses the first portion.

15. A drive device comprising:
the motor according to claim 10; and
a decelerator coupled to the motor; wherein
the motor is transversely positioned;
a refrigerant to circulate inside the motor and the decelerator is provided; and
the motor housing includes:
a refrigerant supply to flow a refrigerant on an upper surface of the stator; and
a refrigerant flow path that includes a groove that circumferentially crosses the third portion.
